(19) United States
(12) Patent Application Publication
(10) Pub. No.: US 2025/0109778 A1
(43) Pub. Date: Apr. 3, 2025

(54) PISTON FOR BUFFER DEVICE AND BUFFER DEVICE

(71) Applicant: Hitachi Astemo, Ltd., Hitachinaka-shi (JP)

(72) Inventors: Tomoaki SHINOZAKI, Hitachinaka-shi (JP); Tsutomu NAITO, Hitachinaka-shi (JP)

(73) Assignee: Hitachi Astemo, Ltd., Hitachinaka-shi (JP)

(21) Appl. No.: 18/728,732

(22) PCT Filed: Mar. 31, 2022
(86) PCT No.: PCT/JP2022/016557

§ 371 Date: Jul. 12, 2024

(51) Int. Cl. F16F 9/348; F16F 9/32

(52) U.S. Cl. CPC F16F 9/3481; F16F 9/3214

(57) ABSTRACT

A piston includes a body of a cylindrical shape and a seat protruding axially from an axial end face of the body. The body includes first through-holes and second through-holes axially extending through the body. The seat allows a planar valve to be seated thereon and includes: bottom surfaces each including an opening for a through-hole formed at a position facing the corresponding first through-hole; a seating surface provided around each bottom surface so as to protrude from the bottom surface; and intermediate portions provided between the end face and the seating surface. The seating surface allows the valve to be seated thereon.

### CROSS-REFERENCE TO RELATED PATENT APPLICATIONS

This application is a U.S. National Phase Application under 35 U.S.C. § 371 of International Patent Application No. PCT/JP2022/016557 filed on Mar. 31, 2022, the content of which is incorporated herein by reference in its entirety. The International Application was published in Japanese on Oct. 5, 2023 as International Publication No. WO/2023/188285 under PCT Article 21 (2).

### FIELD OF THE INVENTION

The present invention relates to a piston for buffer devices and a buffer device.

### BACKGROUND OF THE INVENTION

For example, Japanese Patent Application Laid-Open Publication No. 2000-257659 discloses a piston for hydraulic buffers that includes partially raised portions relative to the reference surfaces on the piston side faces. Extension-side and compression-side oil channels for passage of oil are formed extending through the raised portions, and valve seat surfaces for disk valves are formed on the respective raised portions. The piston for hydraulic buffers disclosed in Japanese Patent Application Laid-Open Publication No. 2000-257659 is made of a sintered body, and the peripheral edge of each valve seat surface is connected to the corresponding reference surface by gentle slopes.

### CITATION LIST

### Patent Literature

Patent Literature 1: Japanese Patent Application Laid-Open Publication No. 2000-257659

### Technical Problem

There is room for further improvements to the piston disclosed in Japanese Patent Application Laid-Open Publication No. 2000-257659 in terms of suppressing any sound that may be generated as oil passes through the piston.

It is an object of the present invention to provide a piston for buffer devices and the like that can suppress any sound that may be generated as oil passes through the piston.

### SUMMARY OF THE INVENTION

### Solution to Problem

With the above object in view, there is provided a piston for buffer devices for use in buffer devices according to an aspect of the present invention. The piston includes: a body of a cylindrical shape, the body including a first through-hole and a second through-hole extending through the body in a centerline direction of the body; and a seat protruding in the centerline direction from an end face of the body in the centerline direction, the seat allowing a planar valve to be seated thereon. The seat comprises: an opening surface including an opening for a communication channel formed at a position facing the first through-hole: a seating surface provided around the opening surface so as to protrude from the opening surface, the seating surface allowing the valve to be seated thereon; and an intermediate portion provided between the end face and the seating surface.

### Advantageous Effects of Invention

The present invention can provide a piston for buffer devices that can suppress any sound that may be generated as oil passes through the piston.

### BRIEF DESCRIPTION OF THE DRAWINGS

FIG. 1 illustrates an example schematic configuration of a suspension device according to a first embodiment.

FIG. 2 is a perspective view illustrating an example piston according to the first embodiment.

FIG. 3 illustrates an example cross-section of part III-III in FIG. 2.

FIG. 4 is an example cross-sectional view illustrating an oil flow during an extension stroke where the amount by which a rod protrudes from a cylinder unit (the protruding amount) increases.

FIG. 5 is an example cross-sectional view illustrating an oil flow during a compression stroke where the protruding amount of the rod decreases.

FIG. 6 illustrates an example oil flow in the piston during an extension stroke.

FIG. 7 illustrates an example oil flow in the piston during a compression stroke.

FIG. 8 is an example perspective view of a piston according to a comparative example.

FIG. 9 illustrates an example cross-section of a piston according to a second embodiment.

FIG. 10 illustrates an example view of a piston according to a third embodiment as viewed from the second side in the axial direction.

### DETAILED DESCRIPTION OF THE INVENTION

Exemplary embodiments of the present invention will be detailed below with reference to the appended drawings.

### First Embodiment

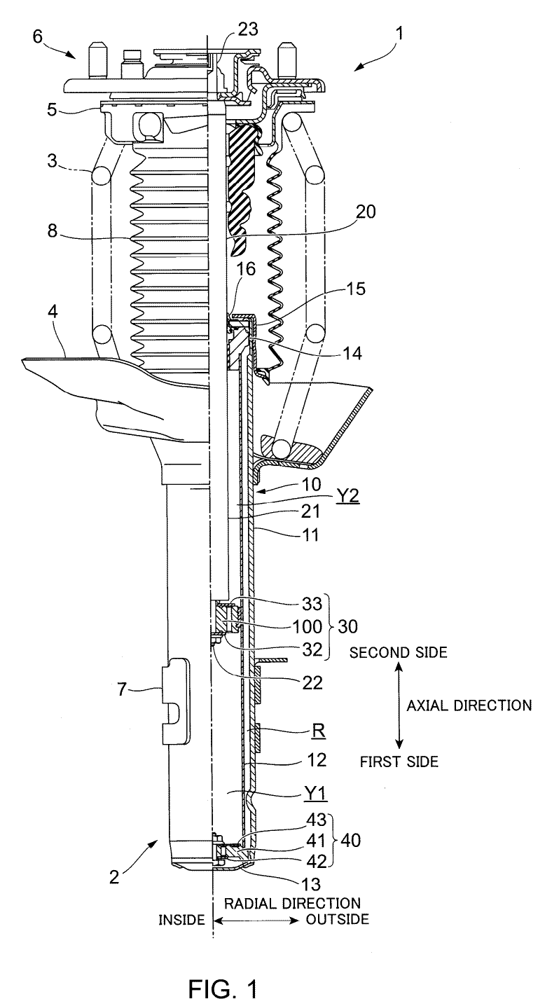

FIG. 1 illustrates an example schematic configuration of a suspension device 1 according to a first embodiment.

The suspension device 1 is a suspension strut and, as shown in FIG. 1, includes a hydraulic buffer device 2 and a coil spring 3 disposed outside the hydraulic buffer device 2. The suspension device 1 further includes a lower spring seat 4 and an upper spring seat 5, where the lower spring seat 4 supports an end of the coil spring 3 on the first side (lower side in FIG. 1) in the axial direction of a rod 20 (described below), and the upper spring seat 5 supports the other end of the coil spring 3 on the second side (upper side in FIG. 1) in the axial direction of the rod 20. The axial direction of the rod 20 may be referred to hereinafter simply as the “axial direction.”

The suspension device 1 includes a vehicle body-side bracket 6 and a wheel-side bracket 7, where the vehicle body-side bracket 6 is attached to a second side end for attaching the suspension device 1 to the vehicle, and the wheel-side bracket 7 is secured to a first side end of a cylinder unit 10 (described below) for attaching the suspension device 1 to a wheel. The suspension device 1 further includes a dust cover 8 to cover at least portions of the cylinder unit 10 and the rod 20. The vehicle body-side bracket 6 is attached to a second side end of the rod 20 (described below).

The hydraulic buffer device 2 is now detailed.

The hydraulic buffer device 2 includes the cylinder unit 10 to contain oil and the rod 20 having the second side end protruding from the cylinder unit 10 and the first side end slidably inserted into the cylinder unit 10. The hydraulic buffer device 2 further includes a piston unit 30 provided at the first side end of the rod 20 and a bottom unit 40 provided at the first side end of the cylinder unit 10.

### (Cylinder Unit 10)

The cylinder unit 10 includes a thin-walled, cylindrical outer cylinder 11 and a thin-walled, cylindrical inner cylinder 12 housed in the outer cylinder 11. The outer and inner cylinders 11, 12 are arranged such that their centerlines are oriented in the axial direction. The cylinder unit 10 further includes a bottom lid 13 to close the lower end thereof. The cylinder unit 10 includes a reservoir chamber R defined between the outer circumference of the inner cylinder 12 and the inner circumference of the outer cylinder 11. The interior of the outer cylinder 11 is filled with oil as an example of a fluid. Alternatively, the interior of the outer cylinder 11 may be filled with a liquid such as water or a gas such as air. Hereinafter, the side radially closer to the centerline of the outer cylinder 11 may be referred to as the “inside,” and the side radially opposite the centerline side may be referred to as the “outside.”

The cylinder unit 10 includes a rod guide unit 14 located inside the outer cylinder 11 to close the upper end of the inner cylinder 12 and movably (slidably) support the rod 20, and a bump stopper cap 15 attached to the upper end of the outer cylinder 11. The cylinder unit 10 further includes an oil seal 16 located on the top of the outer cylinder 11 to prevent oil from leaking from the outer cylinder 11 and foreign matters from entering the outer cylinder 11.

### (Rod 20)

The rod 20 is a solid or hollow member of a stick shape and includes a columnar or cylindrical rod portion 21. The rod 20 further includes a lower attaching portion 22 for attaching the piston unit 30 to the lower end thereof and an upper attaching portion 23 for attaching the vehicle body-side bracket 6 to the upper end thereof. The lower and upper attaching portions 22, 23 are provided with male threads on their ends.

### (Bottom Unit 40)

The bottom unit 40 includes a valve body 41 with multiple oil channels extending axially therethrough, a first valve 42 provided on the first side of the valve body 41, and a second valve 43 provided on the second side of the valve body 41.

The valve body 41 of the bottom unit 40 provides a partition between a first oil chamber Y1 (described below) and the reservoir chamber R.

### (Piston Unit 30)

The piston unit 30 includes a piston 100, a first valve 32 to close first side ends of some of multiple oil channels formed in the piston 100, and a second valve 33 to close second side ends of some oil channels formed in the piston 100.

By way of example, the first and second valves 32, 33 may each be a thin annular member. The first and second valves 32, 33 may each comprise a group of valves composed of thin annular members stacked on top of each other.

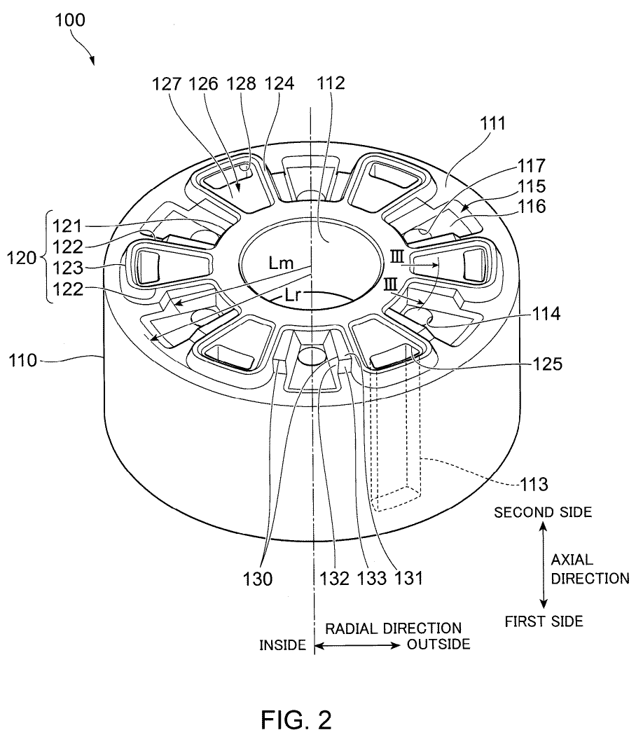

FIG. 2 is a perspective view illustrating an example of the piston 100 according to the first embodiment.

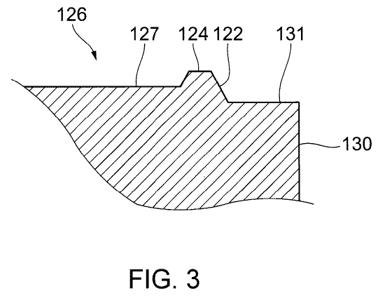

FIG. 3 illustrates an example cross-section of part III-III in FIG. 2.

The piston 100 contacts the inner circumference of the inner cylinder 12 via a member that is provided on the outer circumference of the piston 100 to seal the gap between the outer circumference of the piston 100 and the inner circumference of the inner cylinder 12, thereby partitioning the oil-filled space within the inner cylinder 12 into a first oil chamber Y1 on the first side relative to the piston 100 and a second oil chamber Y2 on the second side relative to the piston 100.

The piston 100 includes a cylindrical body 110 disposed with its centerline extending in the axial direction and a seat 120 protruding from an axial end face 111 of the body 110 toward the second axial side in the axial direction and allowing the second valve 33 to be seated on the seat 120. The body 110 and the seat 120 are integrally formed by, for example, sintering.

The body 110 includes a central hole 112 in a radially inside portion thereof, through which the rod 20 is inserted. Around the central hole 112, the body 110 includes multiple first through-holes 113 (six in FIG. 2) and multiple second through-holes 114 (six in FIG. 2) arranged circumferentially and extending axially through the body 110. The multiple first and second through-holes 113, 114 are arranged to alternate circumferentially. It should be noted that the multiple first and second through-holes 113, 114 need not alternate one by one, but may alternate two by two or three by three. Alternatively, the first and second through-holes 113, 114 may respectively be grouped together. When viewed in the axial direction, the first through-holes 113 are of a generally rectangular shape and the second through-holes 114 are of a circular shape. However, the shapes of the first and second through-holes 113, 114 are not limited to these, and may have shapes with two or more cross-sectional profiles, such as a spindle shape. The first through-holes 113 are formed at radially outside positions relative to the second through-holes 114.

The body 110 includes recesses 115 axially depressed toward the first side from the end face 111 perpendicular to the axial direction. The recesses 115 are formed in regions where the seat 120 is not formed. Each recess 115 is formed around the corresponding second through-hole 114, and an opening 117 for the second through-hole 114 is formed in a bottom surface 116 of the recess 115.

The seat 120 includes a central portion 121 provided around the central hole 112 of the body 110, pairs of radial portions 122 extending radially from the central portion 121, and circumferential portions 123 each extending circumferentially so as to connect the outside radial ends of the corresponding pair of radial portions 122. The axial end faces of the central portion 121, the pairs of radial portions 122, and the circumferential portions 123 are at the same axial level, so that they serve as a seating surface 124 on which the second valve 33 is seated.

The seat 120 includes through-holes 125 extending axially therethrough and formed at positions facing the respective first through-holes 113 formed in the body 110. The through-holes 125 are identical in shape to the first through-holes 113, and the through-holes 125 and the respective first through-holes 113 are axially continuous. As many through-holes 125 as the number of first through-holes 113 are formed.

Each pair of radial portions 122 and the corresponding circumferential portion 123 are provided to enclose the corresponding through-hole 125 with the periphery of the central portion 121, and as many sets of the pair of radial portions 122 and the circumferential portion 123 as the number of through-holes 125 (six in FIG. 2) are circumferentially provided.

The portion enclosed by the central portion 121, the corresponding pair of radial portions 122, and the corresponding circumferential portion 123 defines a recess 126 depressed from the seating surface 124, and an opening 128 for the corresponding through-hole 125 is formed in a bottom surface 127 of the recess 126. The bottom surface 127 is located closer to the seating surface 124, on which the second valve 33 is seated, than the end face 111 of the body 110 is.

The seat 120 includes intermediate portions 130 provided between the end face 111 of the body 110 and the seating surface 124. Each intermediate portion 130 is provided opposite the recess 126 with respect to the corresponding radial portion 122 and extends radially from the central portion 121. By way of example, the intermediate portions 130 may be of a cuboid shape. A second side axial end face 131 of each intermediate portion 130 is perpendicular to the axial direction, and a circumferential end face 132 and a radial end face 133 of each intermediate portion 130 are parallel to the axial direction. However, the end faces 132, 133 may be inclined with respect to the axial direction.

Since the end face 131 is perpendicular to the axial direction and the radial portion 122 is inclined with respect to the axial direction from the seating surface 124 toward the corresponding recess 126, a connection between the end face 131 and the radial portion 122 forms an obtuse angle, as shown in FIG. 3.

The axial size of the intermediate portions 130, i.e., the protruding amount of the intermediate portions 130 from the end face 111 of the body 110 is smaller than the protruding amount of the radial portions 122 from the end face 111. By way of example, the protruding amount of the intermediate portions 130 from the end face 111 may be 40% to 90% of the protruding amount of the radial portions 122 from the end face 111.

The radial size of the intermediate portions 130 is smaller than the radial size of the radial portions 122. By way of example, the radial size Lm of the intermediate portions 130 may be 20% to 80% of the radial size Lr of the radial portions 122. The size Lm may be preferably 50% to 70%, more preferably 70%, of the size Lr.

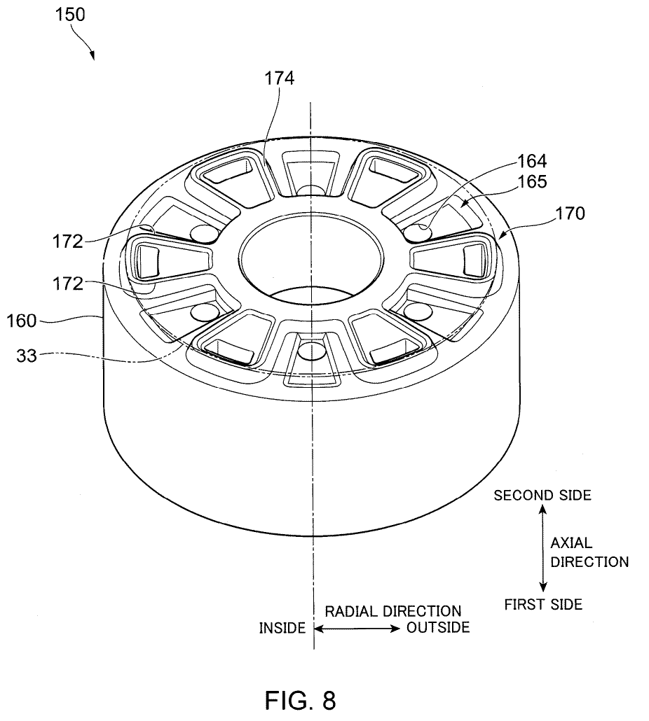

By providing each intermediate portion 130 continuously with the corresponding radial portion 122 so as to be opposite the recess 126 with respect to the radial portion 122, it is possible to reduce sink marks on the powdered material of the radial portions 122 that may occur during a sizing process in manufacturing the piston 100 by sintering. In addition, by virtue of the size Lm being 50% to 70% of the size Lr, rigidity difference between the rigidity of the second side ends of the radial portions 122 and the rigidity of the second side ends of the circumferential portions 123 can be reduced. For example, by virtue of the size Lm being 70% of the size Lr, the rigidity difference can be reduced by about 60% compared to a configuration without the intermediate portions 130 (the configuration of a piston 150 according to a comparative example shown in FIG. 8).

### (Functions of the Hydraulic Buffer Device 2)

Operations of the hydraulic buffer device 2 according to the first embodiment are now detailed.

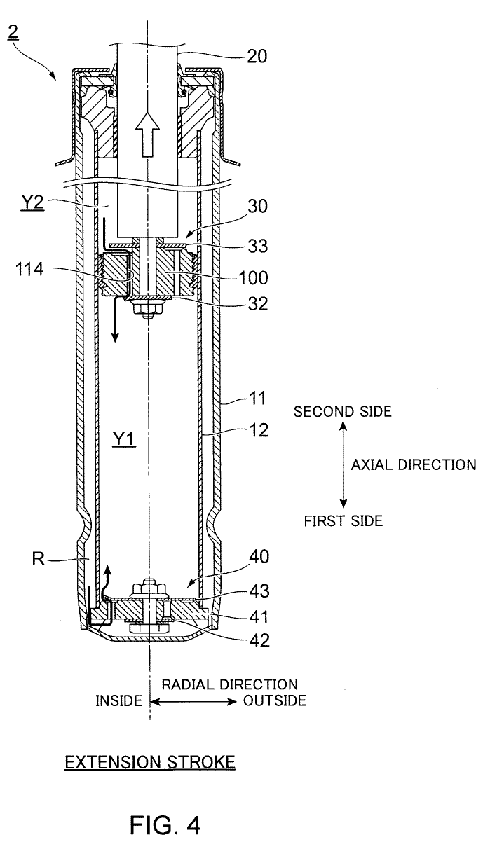

FIG. 4 is an example cross-sectional view illustrating an oil flow during an extension stroke where the amount by which the rod 20 protrudes from the cylinder unit 10 (protruding amount) increases.

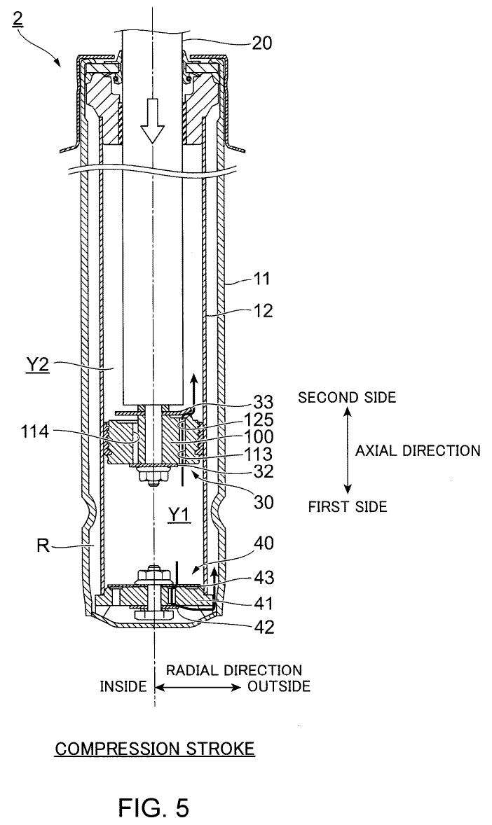

FIG. 5 is an example cross-sectional view illustrating an oil flow during a compression stroke where the protruding amount of the rod 20 decreases.

During an extension stroke, the rod 20 moves toward the second side with respect to the inner cylinder 12, as shown in FIG. 4. The movement of the piston unit 30 toward the second side increases the pressure in the second oil chamber Y2, causing the oil in the second oil chamber Y2 to pass through the second through-holes 114 of the piston 100 and open the first valve 32 to flow into the first oil chamber Y1. The pressure in the first oil chamber Y1 becomes relatively lower than that in the reservoir chamber R, so that the oil in the reservoir chamber R opens the second valve 43 of the bottom unit 40 to flow into the first oil chamber Y1. These generate a damping force.

During a compression stroke, the rod 20 moves toward the first side with respect to the inner cylinder 12, as shown in FIG. 5. The movement of the piston unit 30 toward the first side increases the pressure in the first oil chamber Y1, causing the oil in the first oil chamber Y1 to pass through the first through-holes 113 and the through-holes 125 of the piston 100 and open the second valve 33 to flow into the second oil chamber Y2. The pressure in the first oil chamber Y1 becomes relatively higher than that in the reservoir chamber R, so that the oil in the first oil chamber Y1 opens the first valve 42 of the bottom unit 40 to flow into the reservoir chamber R. These generate a damping force.

### (Oil Flow in the Piston 100)

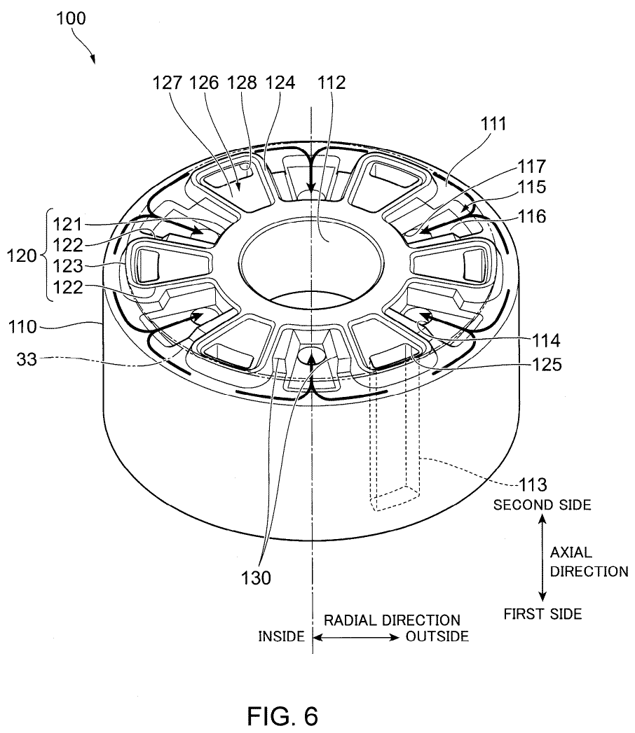

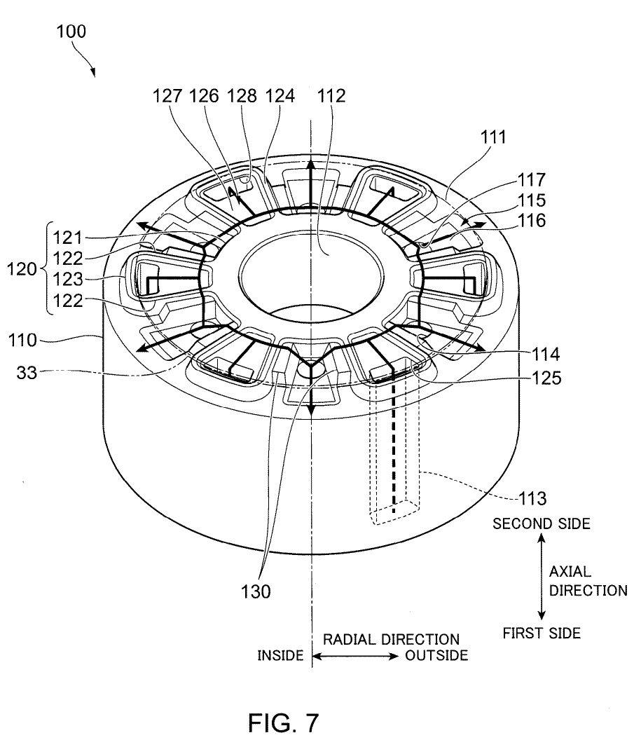

FIG. 6 illustrates an example oil flow in the piston 100 during an extension stroke. FIG. 7 illustrates an example oil flow in the piston 100 during a compression stroke. In FIGS. 6 and 7, the piston 100 is illustrated as being viewed at an angle from the second side in the axial direction, with the illustration of the second valve 33 omitted.

FIG. 8 is an example perspective view of a piston 150 according to a comparative example.

During an extension stroke, as shown in FIG. 6, the second valve 33 is in contact with the seating surface 124 of the seat 120 of the piston 100, so that in the axial direction, the oil in the second oil chamber Y2 passes between the body 110 of the piston 100 and the second valve 33 to reach the second through-holes 114. More specifically, in the axial direction, the oil passes between the end face 111 of the body 110 and the second valve 33 and enter the recesses 115 to flow into the second through-holes 114. In the radial direction, the oil passes between adjacent radial portions 122 of the seat 120 and then between adjacent intermediate portions 130 to flow into the second through-holes 114. Hence, during the extension stroke, the flow area for the oil flowing from the second oil chamber Y2 to the first oil chamber Y1 decreases in steps. That is, the most upstream flow area defined by the gap between the second valve 33, the recess 115 of the body 110, and the corresponding adjacent radial portions 122 of the seat 120 is the largest, and the most downstream flow area in the second through-hole 114 is the smallest. And the midstream flow area defined by the gap between the second valve 33, the recess 115 of the body 110, and the corresponding adjacent intermediate portions 130 of the seat 120 is smaller than the most upstream flow area and larger than the most downstream flow area. As a result, the flow velocity of the oil flowing from the second oil chamber Y2 to the first oil chamber Y1 decreases in steps.

Here, we consider an oil flow in a piston 150 according to a comparable example. In a distinction from the piston 100 according to the first embodiment, the piston 150 according to the comparative example does not include the intermediate portions 130. The same elements between the piston 150 and the piston 100 are given the same names, and their detailed descriptions are omitted. However, in FIG. 8, different reference numerals are used to identify the same elements between the piston 150 and the piston 100.

In the piston 150 according to the comparative example, which does not include the intermediate portions 130, the flow area for the oil flowing from the second oil chamber Y2 to the first oil chamber Y1 suddenly decreases from the flow area defined by the gap between the second valve 33, a recess 165 of a body 160, and corresponding adjacent radial portions 172 of a seat 170 to the flow area inside a second through-hole 164. Hence, the flow velocity of the oil flowing from the second oil chamber Y2 to the first oil chamber Y1 suddenly decreases, resulting in a sudden change in dynamic pressure. As a result, sound may be generated as the oil flows from the second oil chamber Y2 to the first oil chamber Y1.

In contrast, in the piston 100 according to the first embodiment, the flow velocity of the oil flowing from the second oil chamber Y2 to the first oil chamber Y1 decreases in steps, which can suppress any sound that may be generated as the oil flows, as compared to the piston 150 according to the comparative example.

During a compression stroke, as shown in FIG. 7, oil flowing from the first oil chamber Y1 through the first through-holes 113 and through-holes 125 opens the second valve 33 and passes between the second valve 33 and the seating surface 124 of the seat 120 to flow into the second oil chamber Y2. A portion of the oil flowing into the second oil chamber Y2 passes between the second valve 33 and the intermediate portions 130 and then between the second valve 33 and the recesses 115 of the body 110. Hence, the flow area for the oil flowing from the first oil chamber Y1 to the second oil chamber Y2 during a compression stroke increases in steps. That is, the most upstream flow area defined by the gap between the second valve 33 and the seating surface 124 of the seat 120 is the smallest, and the most downstream flow area defined by the gap between the second valve 33 and the recess 115 of the body 110 is the largest. And the midstream flow area defined by the gap between the second valve 33 and the intermediate portion 130 is larger than the most upstream flow area and smaller than the most downstream flow area. As a result, the flow velocity of the oil flowing from the first oil chamber Y1 to the second oil chamber Y2 increases in steps.

In the piston 150 according to the comparative example, which does not include the intermediate portions 130, the flow velocity of the oil flowing from the first oil chamber Y1 to the second oil chamber Y2 through the recesses 165 of the body 160 suddenly increases. That is, the flow area for the oil flowing from the first oil chamber Y1 to the second oil chamber Y2 through the recesses 165 of the body 160 suddenly increases from the flow area defined by the gap between the second valve 33 and an end face 174 of the seat 170 to the flow area defined by the gap between the second valve 33 and the recess 165 of the body 160. Hence, the flow velocity of the oil flowing from the first oil chamber Y1 to the second oil chamber Y2 suddenly increases. This results in large sound being generated as the oil flows from the first oil chamber Y1 to the second oil chamber Y2.

In contrast, in the piston 100 according to the first embodiment, the flow velocity of the oil flowing from the first oil chamber Y1 to the second oil chamber Y2 through the recesses 115 of the body 110 increases in steps, which can suppress any sound that may be generated as the oil flows, as compared to the piston 150 according to the comparative example.

As described above, the piston 100 is an example of the piston for the hydraulic buffer device 2 and includes: the body 110 of a cylindrical shape and including the first through-holes 113 and the second through-holes 114 axially extending through the body 110; and the seat 120 protruding axially from the axial end face 111 of the body 110 and allowing the planar second valve 33 to be seated on the seat 120. The seat 120 includes: the bottom surfaces 127, as an example of the opening surface, each including the opening 128 for the corresponding through-hole 125, as an example of the communication channel, formed at the position facing the corresponding first through-hole 113; and the seating surface 124 provided around each bottom surface 127 so as to protrude therefrom and allowing the second valve 33 to be seated on the seating surface 124. The seat 120 includes the intermediate portions 130 provided between the end face 111 of the body 110 and the seating surface 124. This piston 100 can cause the flow velocity of the oil to decrease in steps, which can suppress any sound that may be generated as the oil flows.

Four or more even-numbered first through-holes 113 (six in FIG. 6) and four or more even-numbered second through-holes 114 (six in FIG. 6) are formed such that they circumferentially alternate, and the opening 117 of each second through-hole 114 is located at a position recessed from the end face 111. This helps circumferentially homogenize the amount of oil flowing from the second oil chamber Y2 to the first oil chamber Y1 through the second through-holes 114 and also helps the oil enter the second through-holes 114. As a result, this can reduce changes in the flow velocity of the oil flowing from the second oil chamber Y2 to the first oil chamber Y1, which in turn can suppress any sound that may be generated as the oil flows.

The seat 120 further includes the central portion 121 provided around the central hole 112 of the body 110, the pairs of radial portions 122 extending radially from the central portion 121, and the circumferential portions 123 each extending circumferentially so as to connect the outside radial ends of the corresponding pair of radial portions 122. This allows the second valve 33 to reliably contact the seating surface 124 of the seat 120 during extension strokes and allows the second valve 33 to quickly open during compression strokes.

Each intermediate portion 130 is provided opposite the bottom surface 127 with respect to the corresponding radial portion 122 and extends radially from the central portion 121. This allows the flow velocity of the oil flowing from the second oil chamber Y2 to the first oil chamber Y1 to decrease in steps during extension strokes and allows the flow velocity of the oil flowing from the first oil chamber Y1 to the second oil chamber Y2 to increase in steps during compression strokes.

### Second Embodiment

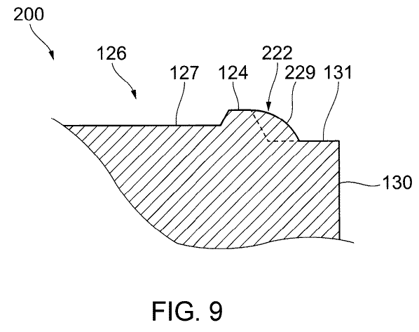

FIG. 9 illustrates an example cross-section of a piston 200 according to a second embodiment. FIG. 9 is a cross-sectional view of the piston 200 taken along a plane perpendicular to the radial direction, similarly to the cross-section of part III-III in FIG. 2.

A distinction of the piston 200 from the piston 100 according to the first embodiment relates to the shape of radial portions 222, which correspond to the radial portions 122. The distinction from the first embodiment is described below. The same reference numerals are used to identify the same elements between the first and second embodiments, and detailed descriptions thereof are omitted.

As shown in FIG. 9, the piston 200 includes an arc-like curved surface 229 at the axial second side end of each radial portion 222, where the surface 229 is convex toward the second side.

In the piston 200 configured as above, the flow velocity of the oil flowing from the first oil chamber Y1 to the second oil chamber Y2 by opening the second valve 33 during compression strokes increases steplessly. That is, the flow area increases steplessly from the flow area defined between the second valve 33 and the seating surface 124 of the seat 120 to the flow area when the oil passes through the gap between the second valve 33 and the curved surface 229. In other words, the flow area in the piston 200 changes more slowly than the flow area in the piston 100. As a result, this can reduce changes in the flow velocity of the oil flowing from the first oil chamber Y1 to the second oil chamber Y2, which in turn can suppress any sound that may be generated as the oil flows.

The circumferential portion 123 may also be provided at its axial second side end with the arc-like curved surface 229 that is convex toward the second side.

### Third Embodiment

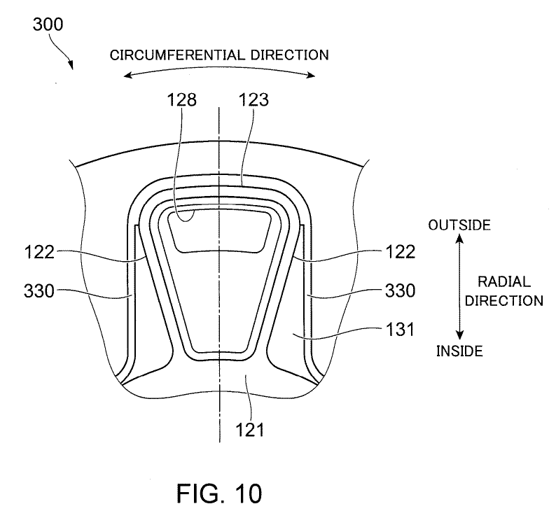

FIG. 10 illustrates an example view of a piston 300 according to a third embodiment as viewed from the second side in the axial direction.

A distinction of the piston 300 from the piston 100 according to the first embodiment relates to intermediate portions 330, which correspond to the intermediate portions 130. The distinction from the first embodiment is described below. The same reference numerals are used to identify the same elements between the first and third embodiments, and detailed descriptions thereof are omitted.

The intermediate portions 330 have a circumferential width that gradually decreases from the radial inside toward the radial outside. In other words, the intermediate portions 330 have a circumferential width that decreases steplessly (e.g., quadratically or linearly) from the radial inside toward the radial outside. The intermediate portions 330 are provided up to the radial outside ends of the radial portions 122.

The piston 300 configured as above can cause the flow area for the oil flowing from the second oil chamber Y2 to the first oil chamber Y1 during extension strokes to decrease steplessly. As a result, this can steplessly decrease the flow velocity of the oil flowing from the second oil chamber Y2 to the first oil chamber Y1, which in turn can suppress any sound that may be generated as the oil flows.

The intermediate portions 330 may have a circumferential width that decreases in steps from the radial inside toward the radial outside, rather than decreasing steplessly.

The axial size of the intermediate portions 330 may be the same as the axial size of the radial portions 122. This allows the flow area for the oil flowing from the second oil chamber Y2 to the first oil chamber Y1 during extension strokes to decrease steplessly over the entire axial length. As a result, this can more reliably suppress any sound that may be generated as the oil flows from the second oil chamber Y2 to the first oil chamber Y1.

The intermediate portions 330 may have a circumferential end face that is parallel to or inclined with respect to the axial direction. For example, the circumferential end face of each intermediate portion 330 may be inclined to connect the circumferential end of the corresponding radial portion 122 in the circumferential direction of the seating surface 124 and the circumferential end of the corresponding recess 126.

### REFERENCE SIGNS LIST

1 Suspension device
2 Hydraulic buffer device
10 Cylinder unit
12 Inner cylinder
20 Rod
30 Piston unit
32 First valve
33 Second valve
100, 200, 300 Piston
110 Body
111 End face
113 First through-hole
114 Second through-hole
117, 128 Opening
120 Seat
121 Central portion
122, 222 Radial portion
123 Circumferential portion
124 Seating surface
125 Through-hole
127 Bottom surface
128 Opening
130, 330 Intermediate portion
229 Curved surface
Y1 First oil chamber
Y2 Second oil chamber

1. A piston for buffer devices for use in hydraulic buffer devices including a cylinder and a rod, the piston comprising:
a body of a cylindrical shape, the body including a central hole provided in a radial center of the body to allow the rod to be inserted therethrough and a plurality of first through-holes and a plurality of second through-holes provided around the central hole and extending through the body in a centerline direction of the body; and
a seat protruding in the centerline direction from an end face of the body in the centerline direction, the seat allowing a planar valve to be seated thereon, wherein
the seat comprises:
an opening surface including an opening for a communication channel formed at a position facing the first through-hole;
a seating surface including a central portion provided around the central hole of the body, a pair of radial portions extending radially from the central portion, and a circumferential portion extending circumferentially so as to connect outside radial ends of the pair of radial portions and forming a recess with the pair of radial portions, the seating surface being provided around the opening surface so as to protrude from the opening surface, the seating surface allowing the valve to be seated thereon; and
an intermediate portion provided between the end face and the seating surface, the intermediate portion extending radially from the central portion and extending from the radial portion on an opposing side of the recess, the intermediate portion having a smaller radial size than the radial portion.

2. The piston for buffer devices according to claim 1, wherein
four or more even number of the first through-holes and four or more even number of the second through-holes are formed such that the first through-holes and the second through-holes circumferentially alternate, and
an opening of each of the second through-holes is provided at a position recessed from the end face.

3-5. (canceled)

6. The piston for buffer devices according to claim 1, wherein a size of the intermediate portion in the centerline direction is smaller than a size of the radial portion in the centerline direction.

7. The piston for buffer devices according to claim 1, wherein at least one of a size in the centerline direction and a circumferential size of the intermediate portion decreases in steps or steplessly as one goes radially from the central portion.

8. The piston for buffer devices according to claim 1, wherein the seat connects to the intermediate portion via a curved surface.

9. A buffer device comprising:
a cylinder of a tubular shape;
a rod of a stick shape, the rod having one axial end thereof inserted in the cylinder; and
a piston secured to the one axial end of the rod, wherein
the piston comprises:
a body of a cylindrical shape, the body including a central hole provided in a radial center of the body to allow the rod to be inserted therethrough and a plurality of first through-holes and a plurality of second through-holes provided around the central hole and extending through the body in a centerline direction of the body; and
a seat protruding in the centerline direction from an end face of the body in the centerline direction, the seat allowing a planar valve to be seated thereon, wherein the seat that comprises:
an opening surface including an opening for a communication channel formed at a position facing the first through-hole;
a seating surface including a central portion provided around the central hole of the body, a pair of radial portions extending radially from the central portion, and a circumferential portion extending circumferentially so as to connect outside radial ends of the pair of radial portions and forming a recess with the pair of radial portions, the seating surface being provided around the opening surface so as to protrude from the opening surface, the seating surface allowing the valve to be seated thereon; and
an intermediate portion provided between the end face and the seating surface, the intermediate portion extending radially from the central portion and extending from the radial portion on an opposing side of the recess, the intermediate portion having a smaller radial size than the radial portion.

10. The piston for buffer devices according to claim 2, wherein a size of the intermediate portion in the centerline direction is smaller than a size of the radial portion in the centerline direction.
